(19) United States
(12) Patent Application Publication
(10) Pub. No.: US 2021/0020909 A1
(43) Pub. Date: Jan. 21, 2021

(54) ELECTRODE MATERIAL AND PREPARATION METHOD THEREOF

(71) Applicant: GIGA SOLAR MATERIALS CORP., Hsinchu (TW)

(72) Inventors: Wen-Chun Yen, Hsinchu (TW); Jian-Shiou Huang, Hsinchu (TW); Chun-Wei Hsu, Hsinchu (TW); Pin-Shen Liou, Hsinchu (TW)

(73) Assignee: GIGA SOLAR MATERIALS CORP., Hsinchu (TW)

(21) Appl. No.: 16/930,307

(22) Filed: Jul. 15, 2020

Related U.S. Application Data
(60) Provisional application No. 62/874,961, filed on Jul. 16, 2019.

(30) Foreign Application Priority Data
Jun. 19, 2020 (TW) 109120712

(51) Int. Cl. H01M 4/134; H01M 4/1395; H01M 4/38; H01M 4/04; H01M 4/133; H01M 4/1393; H01M 4/36; H01M 10/0525

(52) U.S. Cl. CPC H01M 4/134; H01M 4/1395; H01M 4/381; H01M 4/0471; H01M 2004/021; H01M 4/1393; H01M 4/364; H01M 10/0525; H01M 4/133

(57) ABSTRACT

An electrode material and a preparation method thereof are provided. The electrode material includes a particle and a charged irregular geometric porous structure disposed on the surface of the particle. A material of the particle includes silicon, silicon oxide, metal, metal oxide, carbon, graphite or a composite material thereof.

### CROSS-REFERENCE TO RELATED APPLICATION

This application claims the priority benefit of U.S. provisional application Ser. No. 62/874,961, filed on Jul. 16, 2019, and Taiwan application serial no. 109120712, filed on Jun. 19, 2020. The entirety of each of the above-mentioned patent applications is hereby incorporated by reference herein and made a part of this specification.

### BACKGROUND OF THE INVENTION

### 1. Field of the Invention

The invention relates to an electrode material and a preparation method thereof, and particularly to a negative electrode material of a lithium ion battery and a preparation method thereof.

### 2. Description of Related Art

In the existing lithium battery industry, a negative electrode mainly uses graphite materials such as natural graphite or artificial graphite. The graphite has the intrinsic property of low electrochemical potential, and a layered structure of the graphite is just suitable for outward migration and storage of lithium ions. Additionally, a volume change rate caused by the graphite in a charging and discharging process is small, so that the graphite becomes a mainstream material of a negative electrode of a commercial lithium battery at present. However, in recent years, due to light weight and long-acting output of a 3C carrier and an electric vehicle, the requirement on the energy density of the battery is also rapidly improved, and graphite with a theoretical specific capacitance of only 372 mAhg⁻¹ cannot meet the requirement of the future energy storage battery gradually. In contrast, lithium silicon compounds having a specific capacitance of 9 to 11 times of that of the graphite become the technology development mainstream of high-energy-density negative electrode materials.

However, due to high storage capacity characteristics of silicon on lithium ions, silicon lattices are forced to expand by about 400% volume when being alloyed with the lithium ions. Such a high volume expansion rate will cause disconnection of the silicon from each other, resulting in peeling of a pulverized electrode from a current collector. Additionally, a contact area between the silicon and the electrode is reduced, a distance is lengthened, and an electric field cannot effectively act on the electrode, so that the lithium ions and electrons cannot be effectively utilized, rapid degradation of cycles of the battery is caused, and the service life of the battery is greatly reduced. On the other hand, the intrinsic silicon per se is poor in conductivity, so that high internal resistance and low heat dissipation speed are caused, and the performance of the battery is greatly influenced. Based on the above, how to avoid falling of a silicon electrode and improve ion conduction capability of the silicon electrode to prolong the cycle life of a silicon negative electrode is an issue most needed to be preferentially solved for commercialization of the silicon negative electrode at present.

### SUMMARY OF THE INVENTION

The invention provides an electrode material and a preparation method thereof. After a particle, a carbon source and a solvent are mixed, a charged irregular geometric porous structure is generated on a surface of the particle through high-temperature sintering, so as to enhance an adsorption effect with a binder.

The electrode material of the invention includes the particle and the charged irregular geometric porous structure disposed on the surface of the particle. A material of the particle includes silicon, silicon oxide, metal, metal oxide, carbon, graphite or a composite material thereof.

In an embodiment of the invention, a particle diameter of the particle is in a range of 1 nm to 100 μm.

In an embodiment of the invention, the metal or metal oxide includes alkali metal, alkaline-earth metal or transition metal.

In an embodiment of the invention, the charged irregular geometric porous structure increases an original surface area of the particle by 2 times to 50 times.

The preparation method of the electrode material of the invention includes the following steps of: mixing a particle with a carbon source and a solvent; and forming a charged irregular geometric porous structure on a surface of the particle after heat treatment sintering. A material of the particle includes silicon, silicon oxide, metal, metal oxide, carbon, graphite or a composite material thereof.

In an embodiment of the invention, the heat treatment sintering is performed for 0.1 hours to 100 hours at a temperature of 200° C. to 1200° C.

In an embodiment of the invention, the carbon source includes a carbon-hydrogen compound containing metal ions, a carbon-hydrogen-oxygen compound containing metal irons or a combination thereof.

In an embodiment of the invention, the carbon source includes alkalified saccharose, cellulose, alkalified phenolic resin, asphalt, rubber oil coal or a combination thereof.

In an embodiment of the invention, the solvent includes water, methyl alcohol, ethyl alcohol, isopropyl alcohol, acetone, butanone, tetrahydrofuran, benzene, toluene, acetate or a combination thereof.

In an embodiment of the invention, the charged irregular geometric porous structure increases an original surface area of the particle by 2 times to 50 times.

Based on the above, the invention provides the electrode material and the preparation method thereof. After the particle, the carbon source and the solvent are mixed, the charged irregular geometric porous structure is generated on the surface of the particle through high-temperature sintering. The charged irregular geometric porous structure may increase the original surface area of the particle, so as to effectively enhance an adsorption effect with the binder and further improve efficiencies of the battery.

### BRIEF DESCRIPTION OF THE DRAWINGS

FIG. 1 is a schematic diagram of an electrode material according to an embodiment of the invention.

FIG. 2 is a schematic diagram of an electrode material adsorbed to a binder according to an embodiment of the invention.

FIG. 3 is a scanning electron microscope (SEM) image of an unprocessed original appearance of a particle according to an embodiment of the invention.

FIG. 4 is a scanning electron microscope (SEM) image of a particle with a charged irregular geometric porous structure according to an embodiment of the invention.

FIG. 5 is a performance curve diagram of an electrode material according to an embodiment of the invention.

### DESCRIPTION OF THE EMBODIMENTS

In this specification, a range represented by “from a numerical value to another numerical value” is a summary representation that avoids enumerating all numerical values in this range one by one. Therefore, a specific numerical range recorded covers a smaller numerical range defined by a numerical value and another numerical value within this numerical range, as if the numerical values and the smaller numerical range are explicitly written in the specification.

The following makes detailed description by listing embodiments and with reference to accompanying drawings, but the provided embodiments are not intended to limit the scope covered by the invention. In addition, the drawings are drawn only for the purpose of description, and are not drawn according to original sizes.

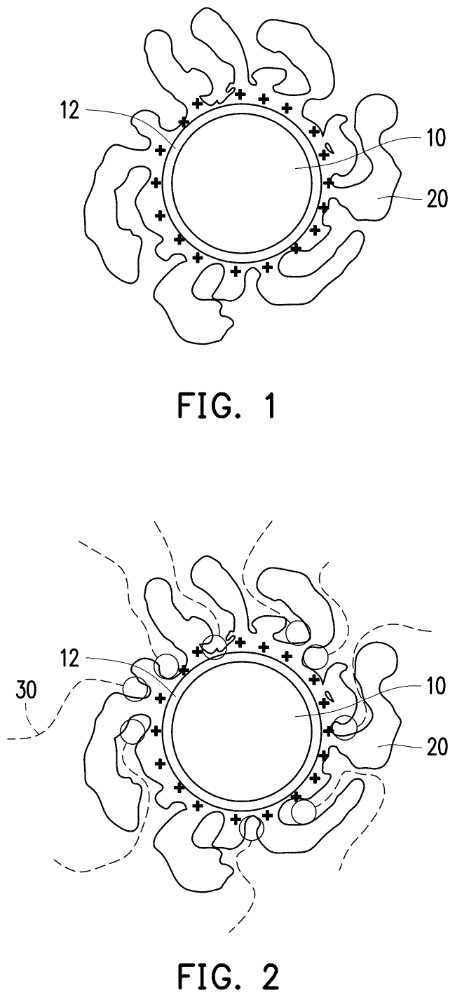

FIG. 1 is a schematic diagram of an electrode material according to an embodiment of the invention. FIG. 2 is a schematic diagram of an electrode material adsorbed to a binder according to an embodiment of the invention.

Referring to FIG. 1, the electrode material of the invention includes a particle 10 and a charged irregular geometric porous structure 20 disposed on a surface of the particle 10. The charged irregular geometric porous structure 20 is, for example, positively charged, but the invention is not limited thereto. In more details, a main body of the charged irregular geometric porous structure 20 is, for example, composed of carbon and parts of metal ions. Charges are mainly from metal ions in a carbon source. A material of the particle 10 may include silicon (including pure silicon or modified silicon, and the modified silicon may be subjected to surface modification by silane or a dispersing agent), silicon oxide, metal, metal oxide, carbon, graphite or a composite material thereof. The metal or metal oxide may include alkali metal (Li/Na/K), alkaline-earth metal (Mg/Ca/Sr/Ba) or transition metal (Ti/Zr/Ta/Cr/W/Mn/Co/Fe/Ni/Cu/Al/Sn/Ge/Ag). In more details, the dispersing agent may mainly include a silane substance. One end of the silane substance preferably, for example, has a silicophilic property, and is easier to be bound with a silicon surface. The other end, for example, has a hydrophilic property or hydrophobic property (depending on hydrophilic and hydrophobic properties of a solution). The silane substance is capable of being dispersed in the solution. In the present embodiment, a material of the particle 10 is, for example, silicon. A silicon oxide layer 12 (SiO_{X}, wherein X=0.1 to 2) may exist between the particle 10 and the charged irregular geometric porous structure 20. A thickness of the silicon oxide layer 12 is, for example, in a range of 0.1 nm to 100 nm, but the invention is not limited thereto. A particle diameter of the particle 10 is, for example, in a range of 1 nm to 100 μm, and the charged irregular geometric porous structure 20 may increase an original surface area of the particle 10 by about 2 times to 50 times.

The invention further provides a preparation method of an electrode material for manufacturing the electrode material in FIG. 1. The preparation method includes: mixing a particle with a carbon source and a solvent, wherein a mixing ratio of the particle to the carbon source to the solvent is, for example, 1:0.01 to 10:0.1 to 9. After heat treatment sintering, a charged irregular geometric porous structure is formed on a surface of the particle. In more details, the heat treatment sintering is, for example, performed for 0.1 hours to 100 hours at a temperature of 200° C. to 1200° C. The carbon source may include a carbon-hydrogen compound containing metal ions (Li/Na/K/Mg/Ca/Sr/Ba/Ti/V/Cr/Mn/Fe/Co/Ni/Cu/Zn/Al/Si/Ge/Ag), a carbon-hydrogen-oxygen compound containing metal irons or a combination thereof. The carbon source may further include alkalified saccharose, cellulose, alkalified phenolic resin, asphalt, rubber oil coal or a combination thereof. The solvent may include water, methyl alcohol, ethyl alcohol, isopropyl alcohol, acetone, butanone, tetrahydrofuran, benzene, toluene, acetate or a combination thereof.

Referring to FIG. 2, through the charged irregular geometric porous structure 20, a binder 30 may go deep into a structure of the particle 10. Further, adhesive force between the binder 30 and the particle 10 is greatly improved by utilizing the characteristic of charge nonuniformity of the binder 30 and an anchor point effect of the charged irregular geometric porous structure 20, and the effect of protecting a silicon and carbon material from expansion is achieved by utilizing the mechanical intensity and toughness of the binder 30. The service life of a battery of the silicon and carbon material is further prolonged. In the present embodiment, the binder 30 is, for example, a negative electrode binder, and may include styrene-butadiene rubber (SBR), poly(acrylic acid) (PAA), polyimide (PI), phenolic resins (PR) or polyacrylonitrile (PN).

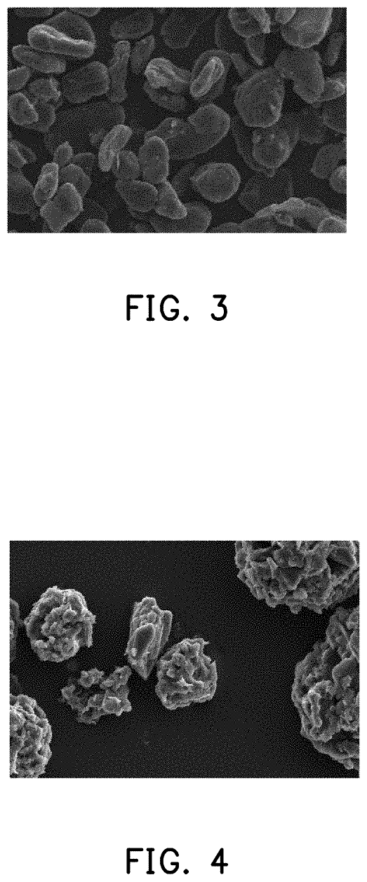

FIG. 3 is a scanning electron microscope (SEM) image of an unprocessed original appearance of a particle according to an embodiment of the invention. FIG. 4 is a scanning electron microscope (SEM) image of a particle with a charged irregular geometric porous structure according to an embodiment of the invention.

Referring to FIG. 3, before the preparation method of the electrode material of the invention is performed, a surface of an unprocessed particle is smooth. Referring to FIG. 4, after the preparation method of the electrode material of the invention is performed, a charged irregular geometric porous structure is disposed on a surface of the particle. In the embodiment shown in FIG. 4, for example, a certain proportion of modified silicon powder, graphite and alkalified saccharose are taken and are mixed into a uniform solution. After drying and shaping, high-temperature 800° C. heat treatment sintering is performed for 2 h.

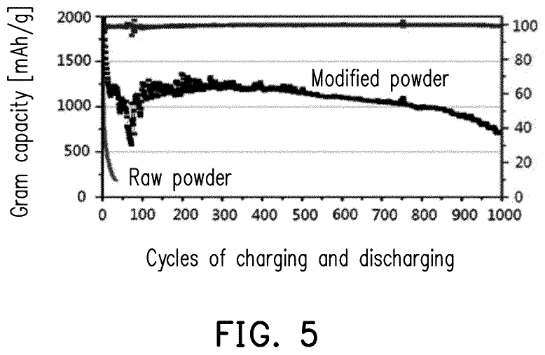

FIG. 5 is a performance curve diagram of an electrode material according to an embodiment of the invention. After the electrode material of the invention is made into a button cell (“modified powder” in FIG. 5) in a conventional mode, comparison is performed with powder not modified by the preparation method of the invention (“raw powder” in FIG. 5, i.e., no charged irregular geometric porous structure is disposed on the particle). As shown in FIG. 5, compared with that of the “raw powder” in FIG. 5, the service life performance of the “modified powder” using the electrode material of the invention in FIG. 5 may be greatly improved.

Based on the above, the invention provides the electrode material and the preparation method thereof. After the particle, the carbon source and the solvent are mixed, the charged irregular geometric porous structure is generated on the surface of the particle through high-temperature sintering. The charged irregular geometric porous structure may increase the original surface area of the particle and enables the binder to go deep into the structure of the particle. Further, the adhesive force between the binder and the particle is greatly improved by utilizing the characteristic of charge nonuniformity of the binder and the anchor point effect of the charged irregular geometric porous structure, and the effect of protecting the silicon and carbon material from expansion is achieved by utilizing the mechanical intensity and toughness of the binder. The service life of a battery of the silicon and carbon material is further prolonged.

What is claimed is:

1. An electrode material, comprising:
a particle, wherein a material of the particle comprises silicon, silicon oxide, metal, metal oxide, carbon, graphite or a composite material thereof; and
a charged irregular geometric porous structure disposed on a surface of the particle.

2. The electrode material according to claim 1, wherein a particle diameter of the particle is in a range of 1 nm to 100 μm.

3. The electrode material according to claim 1, wherein the metal or metal oxide comprises alkali metal, alkaline-earth metal or transition metal.

4. The electrode material according to claim 1, wherein the charged irregular geometric porous structure increases an original surface area of the particle by 2 times to 50 times.

5. A preparation method of an electrode material, comprising:
mixing a particle with a carbon source and a solvent; and forming a charged irregular geometric porous structure on a surface of the particle after heat treatment sintering,
wherein a material of the particle comprises silicon, silicon oxide, metal, metal oxide, carbon, graphite or a composite material thereof.

6. The preparation method according to claim 5, wherein the heat treatment sintering is performed for 0.1 hours to 100 hours at a temperature of 200° C. to 1200° C.

7. The preparation method according to claim 5, wherein the carbon source comprises a carbon-hydrogen compound containing metal ions, a carbon-hydrogen-oxygen compound containing metal irons or a combination thereof.

8. The preparation method according to claim 5, wherein the carbon source comprises alkalified saccharose, cellulose, alkalified phenolic resin, asphalt, rubber oil coal or a combination thereof.

9. The preparation method according to claim 5, wherein the solvent comprises water, methyl alcohol, ethyl alcohol, isopropyl alcohol, acetone, butanone, tetrahydrofuran, benzene, toluene, acetate or a combination thereof.

10. The preparation method according to claim 5, wherein the charged irregular geometric porous structure increases an original surface area of the particle by 2 times to 50 times.
